(19) United States
(12) Patent Application Publication
(10) Pub. No.: US 2011/0299806 A1
(43) Pub. Date: Dec. 8, 2011

(54) SPINDLE, SHAFT SUPPORTING DEVICE AND METHOD OF SUPPORTING A ROTATABLE SHAFT

(76) Inventor: Leonid Kashchenevsky, Plainville, CT (US)

(21) Appl. No.: 13/153,843

(22) Filed: Jun. 6, 2011

Related U.S. Application Data
(60) Provisional application No. 61/352,582, filed on Jun. 8, 2010.

(51) Int. Cl. F16C 35/08; F16C 32/00

(52) U.S. Cl. 384/603; 384/590

(57) ABSTRACT

A spindle includes a shaft, at least one non-contact bearing in operable communication with the shaft, and a housing in operable communication with the at least one non-contact bearing. The shaft is rotatable relative to the housing, and at least one non-contact thrust bearing in operable communication with the shaft is configured to transfer oscillations to the shaft in directions parallel to an axis of the shaft.

### CROSS REFERENCE TO RELATED APPLICATIONS

This application is a non-provisional application of U.S. Provisional Patent Application No. 61/352,582, filed Jun. 8, 2010, the entire contents of which are incorporated herein by reference.

### BACKGROUND

Attaining high accuracy, high productivity and a good surface finish via grinding processes on internal surfaces is typically more difficult than on external surfaces. The difficulty is even greater when the parts are relatively small.

Optimal grinding conditions include specific surface speeds that are dependent upon the material of the part being ground and the type of grinding wheel used. For external grinding, large diameter wheels can be used and attaining the desired surface speed is relatively easy. For grinding of internal surfaces, however, dimensions of available openings limit a grinding wheel's diameter. In such cases very high rotational speeds are needed to attain the desired surface speed. This is particularly true for Cubical Boron Nitride (CBN) wheels that are commonly used when grinding hardened steel, which requires speeds over 100 m/second.

The dimensions of the access opening also restrict the diameter of the arbor onto which the grinding wheel is attached. When very small internal diameters are ground, the arbor is typically the weakest link in the dynamic system. The low stiffness of the grinding wheel arbor is one of the most critical parameters that restrict internal grinding productivity as well as the finished surface quality.

There are many types of internally ground small components that are widely used in different industrial applications that are produced in very high volumes yet also feature extremely challenging requirements for surface finish and geometrical and dimensional accuracy. Examples include:

Fuel injector valve's seat for gasoline and diesel engines;

Bearings rings for high precision, small sizes ball and roller bearings;

Components of bearings for hard disc drives in computers;

Fiber optics connectors; and

Components for micro technology applications: micro robots, micro engines etc.

Additionally, materials widely used in military and commercial applications are difficult to grind using conventional grinding processes. These include materials such as, stainless steel alloys, titanium alloys and aluminum alloys, for example.

Alternative methods to grinding that provide very good surface finish and geometrical and dimensional accuracy include diamond turning. Diamond turning, however, is relatively slow and as such tends to be used only in low volume production. Additionally, only a small number of materials can be machined using diamond turning and this small list does not include stainless steel alloys or titanium alloys. Consequently, operators typically employ low productivity hand operations, such as, lapping or honing, for example, to attain required surface finishes and geometrical accuracy with these materials.

Typical high speed internal grinding machines often referred to in the industry as spindles almost exclusively use precision ball bearings (mainly ceramic hybrid bearings). Some high speed internal grinding spindles use air static bearings, but their use is limited due to low static stiffness, very poor damping ratios and extremely poor durability.

Referring to FIG. 1, typical an internal grinding machine such as that illustrated at 10 provide relatively low frequency axial oscillations via a slide 38 on top of which an internal grinding spindle is mounted. The slide 38 is mounted on a machine base 42 and can move parallel to a rotational axis of an internal grinding spindle 14 by means of a drive mechanism (not shown) such as ball screw, linear electrical motor or a hydraulic cylinder, for example. The internal grinding spindle 14 is mounted on top of the slide 38. Grinding wheel 22 is attached to arbor 18 and moves axially relative to a part 26 that is being ground, which is mounted on the front end of a shaft 30 of a work head grinding spindle 34.

Because of the relatively large mass (combination of slide 38 and internal grinding spindle 14) it is nearly impossible to reach very high axial frequencies of motion. The high oscillating mass will also generate additional vibration of the complete machine that can significantly negatively affect the grinding performance.

Referring to FIG. 2, another typical internal grinding machine is schematically illustrated at 60. This machine employs methods similar to those disclosed in U.S. Pat. Nos. 2,114,343, 3,270,360 and 4,397,055. An external main shaft 68 is hollow and rotates on a ball (or roller) bearings 72. Inside the hollow shaft 68 is internal shaft 76 that is connected to the external hollow shaft 68 by means of splines 88 that force the internal shaft 76 to rotate in sync with the external shaft 68 while allowing it to move axially relative to the spindle housing 64. Reciprocating or oscillating axial motion is generated by via a cam mechanism 84. Rotating springs 80 attempt to maintain contact between cam surfaces 92 of the cam mechanism 84.

Because of the number of mechanical contacts, however, and friction between the cam surfaces 92, frequency of axial oscillations is limited. Increases in loads generated by the springs 80 allow for higher frequencies without separation of the cam surfaces 92 but also causes faster wear.

Because of an unavoidable gap 96 between the external shaft 68 and the internal shaft 76, it is difficult to maintained concentricity between the axial motion and the rotational axis. Additionally, backlash between the two shafts 68 and 76 can generate a wide spectrum of undesirable modes of vibration.

For at least the foregoing reasons the industry would welcome new machines for grinding internal surfaces.

### BRIEF DESCRIPTION

Disclosed herein is a spindle including a shaft, at least one non-contact bearing in operable communication with the shaft, and a housing in operable communication with the at least one non-contact bearing. The shaft is rotatable relative to the housing, and at least one non-contact thrust bearing in operable communication with the shaft is configured to transfer oscillations to the shaft in directions parallel to an axis of the shaft.

Further disclosed herein is a shaft supporting device, including a housing, a shaft in operable communication with the housing, and at least one non-contact bearing in operable communication with the housing and the shaft configured to provide radial support to the shaft. A bearing support is in operable communication with the housing and the shaft via at least one non-contact bearing, and at least one non-contact thrust bearing is in operable communication with the bearing support and the shaft configured to transfer oscillatory motion from the bearing support to the shaft.

Further disclosed is a method of supporting a rotatable shaft, including rotationally supporting a shaft with at least one non-contact bearing, axially positioning the shaft with at least one non-contact thrust bearing, and transferring axial oscillations to the shaft through the at least one non-contact thrust bearing.

### BRIEF DESCRIPTION OF THE DRAWINGS

The following descriptions should not be considered limiting in any way. With reference to the accompanying drawings, like elements are numbered alike:

FIG. 1 depicts a side view of a conventional low frequency oscillating internal grinding machine;

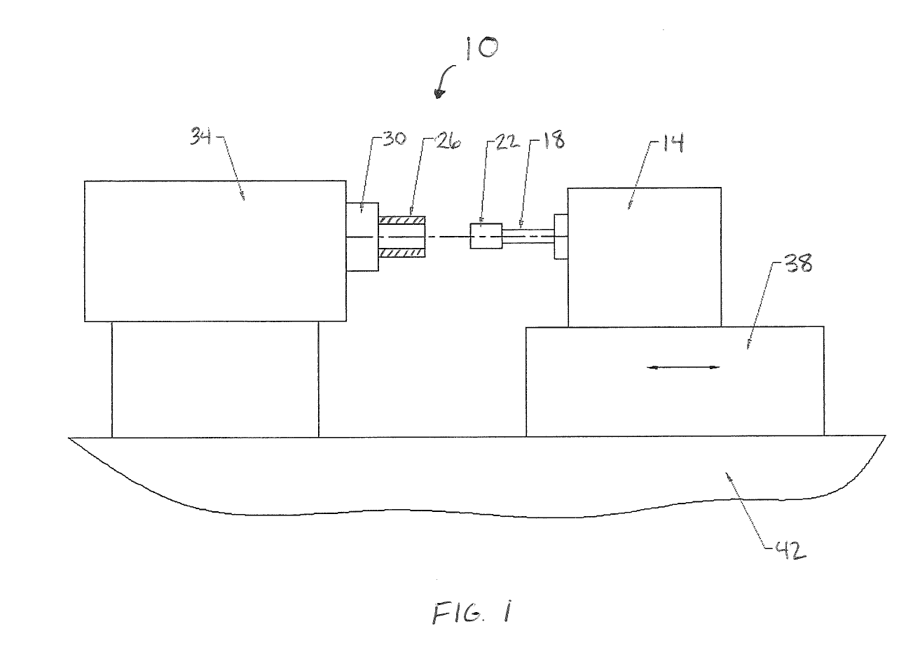

FIG. 2 depicts a partially sectioned view of another conventional oscillating internal grinding machine that combines axial oscillations with shaft rotation;

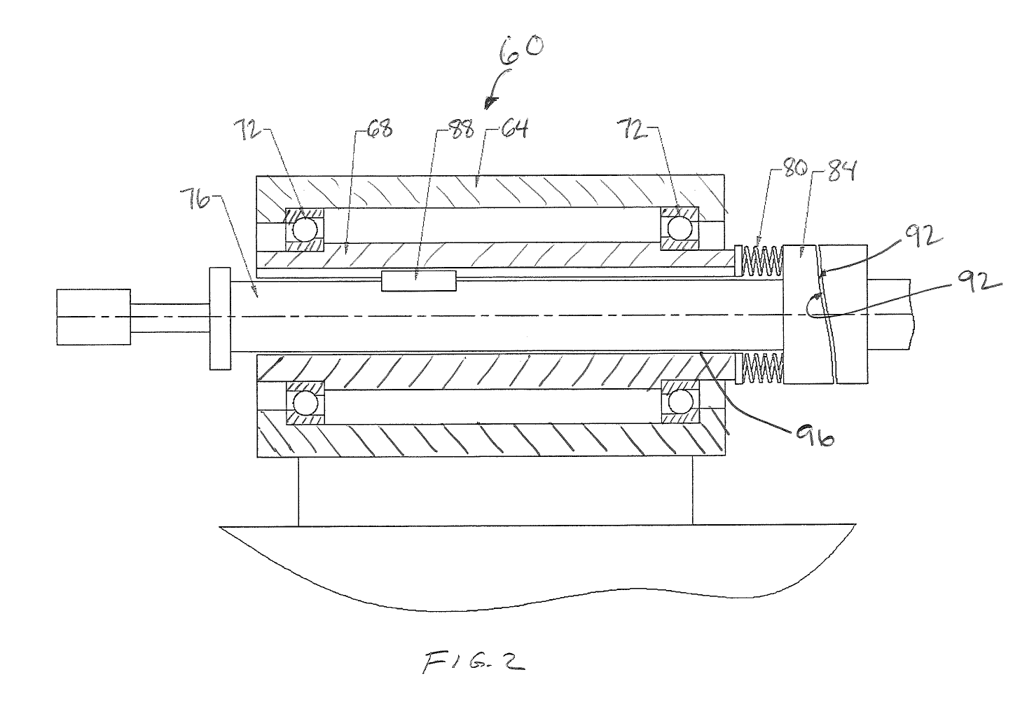

FIG. 3 depicts a partial sectioned view of an embodiment of an internal grinding machine disclosed herein;

FIG. 4 depicts a partial sectioned view an alternate embodiment of a portion of a spindle of the machine of FIG. 3; and

FIG. 5 depicts a partial sectioned view of another alternate embodiment of a portion of the spindle of the machine of FIG. 3.

### DETAILED DESCRIPTION

A detailed description of one or more embodiments of the disclosed apparatus and method are presented herein by way of exemplification and not limitation with reference to the Figures.

A machine employing an ultra-high speed precision hydrostatic spindle with axial oscillations of a rotating shaft disclosed is able to resolve most of the challenging problems for high accuracy and high volume internal grinding. The machine can be effectively employed to grind materials that cannot be ground using conventional grinding equipment.

A hydrostatically supported spindle disclosed herein uniquely combines ultra-high rotational accuracy and extremely high vibration resistance (damping ratio) and has a substantially unlimited life span. In contrast to spindles mounted with ball and roller bearings, spindles mounted via hydrostatic bearings (as well as air-static and electromagnetic bearings) are non-contacting and thus shafts rotating relative thereto can be simultaneously moved rotationally and axially. Such movement includes:
a. Rotational accuracy about 20 to 40 times higher in comparison to precision ball and roller bearings.
b. Extremely high vibration resistance in radial direction permits more aggressive grinding without chatter effects.
c. Bearing life is virtually unlimited while high-speed ball and roller bearing life can be as short as 4-6 weeks depending upon rotational speeds used.

One way to significantly increase the radial load capacity and to reduce spindle sensitivity to overload for ultra-high speed hydrostatic spindles is described in the U.S. Patent Application Publication number 2009/0074337, filed Sep. 5, 2008, the contents of which are included in its entirety herein by reference.

One of the most effective ways to increase productivity and quality for internal grinding are ultrasonic axial oscillations of the grinding wheel relative to the ground surface and superimposed with rotational (tangential) motion. As is described in the book “Cutting with vibrations” written by Prof D. Kumabe (Japan), the contents of which are included in its entirety herein by reference. Employing ultrasonic axial oscillations to the grinding wheel can increase productivity up to four times. Additionally, it can significantly reduce clogging of the grinding wheel by chips from the part being ground thereby permitting grinding of soft and ductile materials. Additionally, very brittle materials such as glass or quartz, for example, can be ground more effectively as well when high frequency axial oscillations are applied to the grinding wheel.

The present invention offers a simple, reliable, and easy to manufacture grinding machine employing cylindrical hydrostatic slides that provide support in radial directions while allowing movements in axial directions. The machine includes a novel design for internal grinding with a hydrostatic spindle in which rotational motion of the shaft is superimposed with high frequency reciprocating (oscillating) axial motion of the shaft. Compared to typical grinding machines, the moving mass and the axial friction are dramatically reduced. Additionally, the axial oscillations are highly concentrically precise relative to an axis of rotation of the shaft, because the same radial journals will act as a slide for the axial motion. Also, since the axial motion is translated to the rotational shaft through the thrust bearings with annular recesses, there are no tilting or radial forces to affect the rotational accuracy of the rotating shaft. The machine disclosed herein effectively combines ultra-high rotational accuracy, ultra-high damping ratio and high frequency axial oscillations including frequencies in the ultrasonic range.

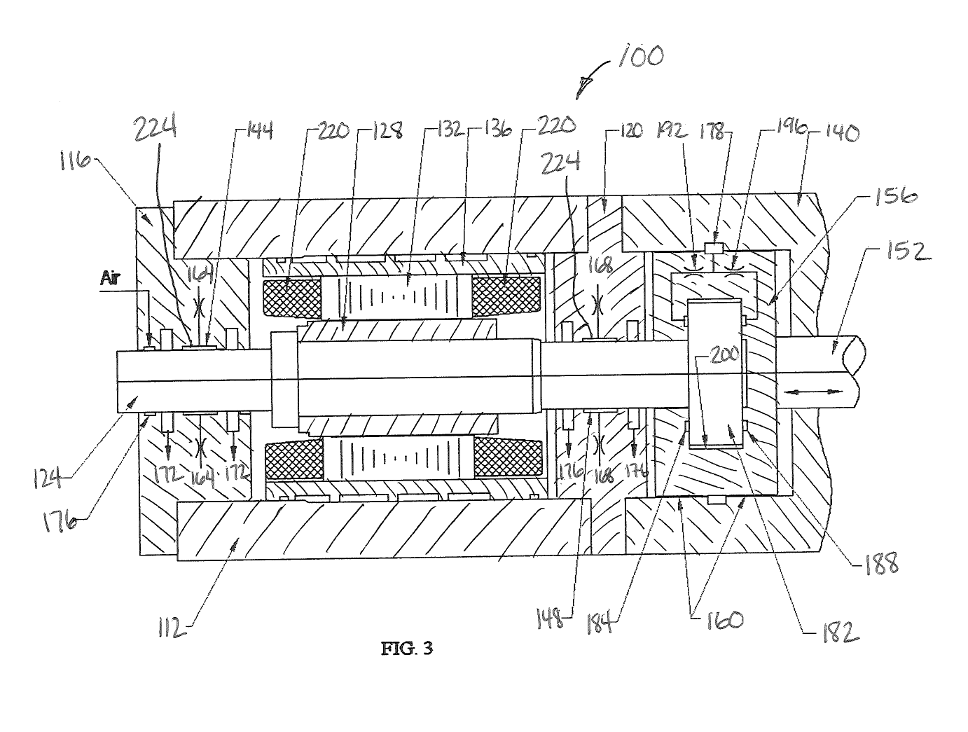

Referring to FIG. 3 an embodiment of an internal grinding machine disclosed herein is illustrated at 100. The machine 100 includes a spindle housing 112, a front bearing bushing 116, a rear bearing bushing 120 and rear housing 140. In this embodiment the housings 112, 140 and the bearing bushings 116, 120 are all fixedly attached to one another. The rear housing 140 is connected to a housing of an oscillation-generating device such as an electromagnetic vibrator, magnetostriction transducer, or a piezoelectric transducer, for example (not shown) that causes a shaft 152 to oscillate axially. A rotatable shaft 124 is supported in the radial direction by a front hydrostatic journal bearing 144 and by a rear hydrostatic journal bearing 148. Optionally, in this embodiment, the shaft 124 is rotated by a high frequency built in electrical motor that has a rotor 128, a stator 132 and a cooling jacket 136, which is used to cool windings 220 of the stator 132. Axial positions of the rotatable shaft 124 are defined by axial positions of the thrust bearing support 156, which is able to move axially relative to the housing 140 along linear slides 160. Axial positions of the thrust bearing support 156 are defined by axial positions of the oscillating shaft 152 to which it is directly connected. Fluid, such as hydraulic oil, is supplied from an external hydraulic unit (not shown) to the front and rear journal recesses 224 of the bearings 144 and 148 through a plurality of inlet restrictors 164 and 168. The restrictors 164, 168 can employ capillaries, orifices or small gaps. As such the bearings 144 and 148 are non-contact bearings in that the shaft 124 rides on a continuous film of fluid and the shaft 124 does not make physical contact with either bearing bushing 116 or 120.

Oil from the journal bearing recesses 224 is directed to annular grooves 172 and 174 that are directly connected to the external hydraulic unit via return lines (not shown). An annular groove 176 is used for air sealing to prevent oil leakage from the bearings outwards and to stop penetration of contamination such as dust or chips outside from reaching the bearing 144. Bushing 182, near a rear portion of the rotatable shaft 124, rotates together with the shaft 124. Axial movement of the bearing support 156 creates thrust in the hydrostatic bearing against annular recesses 184 and 188. Oil, under high pressure, is supplied from an annular groove 178 to the annular recesses 184 and 188 through two inlet restrictors 192 and 196. Axially oscillating shaft 152 forces the thrust bearing support 156 to move axially relative to the stationary housing 140 by means of the linear slides 160. Since the thrust hydrostatic bearing recesses 184 and 188 are annular and chamber 200 is also annular, and all three are supplied with fluid under a common pressure, the hydrostatic thrust bearing 182 will have zero tilting and zero radial forces applied thereto. As such, the hydrostatic thrust bearing will substantially only transfer an axial force to the rotatable shaft 124 with no contact being made between the bearing support 156 and the bushing 182. This axial only force will not negatively affect the ultra-high radial rotational accuracy provided by the journal hydrostatic bearings 144 and 148.

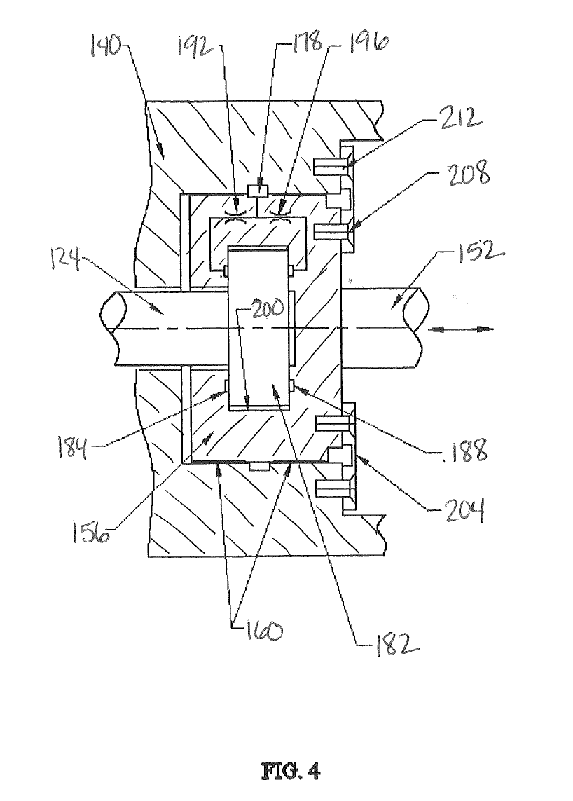

Referring to FIG. 4, an alternate embodiment of a rear portion of the machine 100 is illustrated. One difference from the embodiment of FIG. 3 is the addition of an annular membrane 204 that is connected to the housing 140 by screws 212 and connected to the axially movable bearing support 156 of the thrust bearing by screws 208. The axially oscillating assembly includes, shaft 124, rear thrust bearing bushing 182 and the thrust bearing support 156. If resonance frequency of the membrane 204 is close or equal to the external drive frequency applied to the thrust bearing support 156, power required to drive the oscillating motion will be reduced dramatically. Additionally, the membrane will prevent the bearing support 156 from rotating relative to the housing 140 under frictional drag provided thereto from the bushing 182. Additionally, torsional forces applied to the shaft 152 will be eliminated thereby preventing potentially damaging torsional loads from reaching the oscillating driving device such as a piezoelectric crystal, for example. Piezoelectric crystal drive devices are susceptible to damage from torque even though they are quite durable when loaded axial directions only.

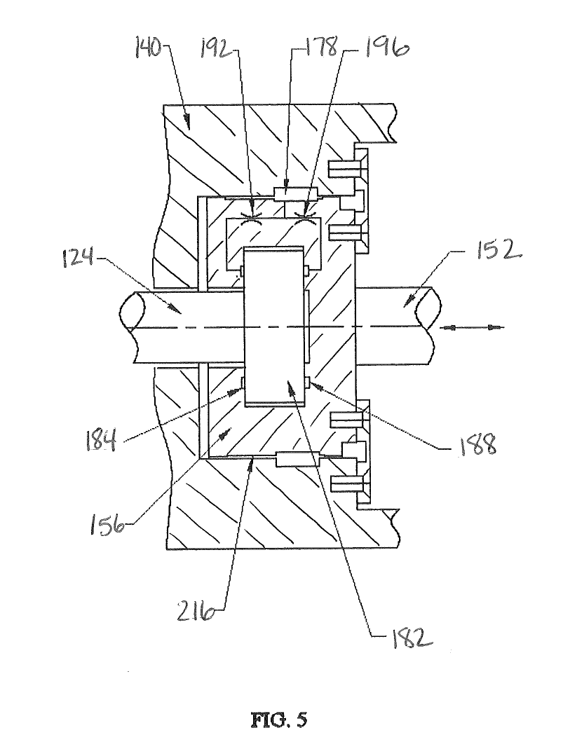

Referring to FIG. 5, an alternate embodiment of a rear portion of the machine 100 of FIG. 3 is illustrated. As in the previous embodiments, fluid under high pressure is directed through the inlet restrictors 192 and 196 to the annular recesses 184 and 188. The pressurized oil is also allowed to move radially to hydrostatic radial support 216. The hydrostatic radial support 216 in this embodiment is a hydrostatic journal bearing that does not require external restrictors. It can, for example, be a stepped bearing (as shown in FIG. 5) or a tapered gap bearing. With said hydrostatic support 216, the system becomes essentially wear free, since there is no physical contact between parts moving axially relative to one another. Axial friction will also be reduced significantly compared to contact type linear slides. Also an extremely high radial damping ratio of the hydrostatic support 216 prevents generation of tilting forces on the bearing support 156 relative to an axis of the shaft 124, and motion in such a direction will be effectively suppressed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A spindle, comprising:
a shaft;
at least one non-contact bearing in operable communication with the shaft;
a housing in operable communication with the at least one non-contact bearing such that the shaft is rotatable relative to the housing; and
at least one non-contact thrust bearing in operable communication with the shaft configured to transfer oscillations to the shaft in directions parallel to an axis of the shaft.

2. The spindle of claim 1, further comprising a bearing support in operable communication with the at least one non-contact thrust bearing.

3. The spindle of claim 2, further comprising an oscillator configured to oscillate the bearing support in a direction parallel to the axis of the shaft.

4. The spindle of claim 2, wherein oscillation of the bearing support is transferred to the shaft through the at least one non-contact thrust bearing.

5. The spindle of claim 2, further comprising a bushing fixed to the shaft and in operable communication with the bearing support via the at least one non-contact thrust bearing.

6. The spindle of claim 2, further comprising a membrane configured to prevent rotation of the bearing support relative to the housing.

7. The spindle of claim 6, wherein a natural frequency of the membrane is selected to be near a frequency of the oscillations to be transferred.

8. The spindle of claim 2, further comprising a non-contact hydrostatic bearing in operable communication between the housing and the bearing support.

9. The spindle of claim 1, wherein the at least one non-contact thrust bearing is two non-contact thrust bearings and each of the two non-contact thrust bearings is configured to urge the shaft in one of two opposing directions.

10. The spindle of claim 1, wherein the at least one non-contact bearing is two non-contact bearings spaced longitudinally from one another.

11. The spindle of claim 1, wherein the at least one non-contact bearing is a journal bearing.

12. The spindle of claim 1, wherein fluid is provided to at least one of the non-contact bearings.

13. The spindle of claim 12, wherein the fluid is pressurized.

14. The spindle of claim 1, further comprising an electrical motor configured to rotate the shaft.

15. A shaft supporting device, comprising:
a housing;
a shaft in operable communication with the housing;
at least one non-contact bearing in operable communication with the housing and the shaft configured to provide radial support to the shaft;
a bearing support in operable communication with the housing and the shaft via at least one non-contact bearing; and
at least one non-contact thrust bearing in operable communication with the bearing support and the shaft configured to transfer oscillatory motion from the bearing support to the shaft.

16. A method of supporting a rotatable shaft, comprising:
rotationally supporting a shaft with at least one non-contact bearing;
axially positioning the shaft with at least one non-contact thrust bearing; and
transferring axial oscillations to the shaft through the at least one non-contact thrust bearing.
